(19) United States
(12) Patent Application Publication
(10) Pub. No.: US 2005/0174603 A1
(43) Pub. Date: Aug. 11, 2005

(54) Information processing apparatus, and information processing system

(75) Inventors: Satoshi Iinuma, Nagano (JP); Yuji Matsueda, Nagano (JP); Yukinobu Momozono, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION, Tokyo (JP)

(21) Appl. No.: 11/035,040

(22) Filed: Jan. 14, 2005

(30) Foreign Application Priority Data
Jan. 14, 2004 (JP) 2004-007248
Jan. 14, 2004 (JP) 2004-007249

(51) Int. Cl. G06F 15/00; G09G 1/14

(52) U.S. Cl. 358/1.16

(57) ABSTRACT

To provide an information processing apparatus which can be operated like a digital multifunction machine having a processing condition registration function and which can be manufactured inexpensively. An information processing apparatus (a digital multifunction machine 10) capable of performing information processing whose details are specified by processing condition specification information is taken as a device capable of storing processing condition specification information about the executed information processing in a management device (a scan agent computer 50) and of reading and utilizing the processing condition specification information stored in the management device (the scan agent computer 50).

### BACKGROUND OF THE INVENTION

The present invention relates to an information processing apparatus, an information processing system.

As is well known, a common digital multifunction machine used in an office, or the like, is an apparatus which enables execution of processing under registered processing conditions through simple operation (normally, an operation for pressing one to three buttons), so long as the processing conditions (copy conditions or the like) have been registered in advance.

This function (hereinafter described as a “processing condition registration function”) is convenient. However, in order to implement this processing condition registration function, the digital multifunction machine must be equipped with a comparatively-large-capacity nonvolatile storage device (normally an HDD). For this reason, an existing digital multifunction machine equipped with a processing condition registration function becomes comparatively expensive.

Accordingly, a problem to be solved by the present invention is to provide an information processing apparatus which can be operated like a digital multifunction machine having a processing condition registration function and which can be manufactured inexpensively.

This processing condition registration function is convenient as described above. However, an existing digital multifunction machine is arranged such that operation for registering processing conditions must be performed intentionally. For this reason (i.e., because registration of processing conditions is troublesome), some users do not utilize the processing condition registration function at all.

Although a plurality of digital multifunction machines are usually installed in an office, even a user who does not find registration of processing conditions troublesome does not register processing conditions in all of the digital multifunction machines in the office. The user does not always memorize details of the registered processing conditions (details of processing conditions required to set in order to achieve a desired result). When performing operation in the office, the user sometimes fails to achieve a desired result, because the processing conditions are not stored in some of the digital multifunction machines which the user desires to use.

Accordingly, a problem to be solved by the invention is to provide an information processing system which includes a plurality of information processing devices (each having information processing execution means capable of performing information processing specified by processing condition specification information), such as digital multifunction machines; and which can readily perform operation corresponding to registration of processing conditions in the respective information processing devices.

### SUMMARY OF THE INVENTION

To solve the problem, the present invention provides an information processing apparatus used while being connected to a network, comprising: processing condition specification information storage means for storing processing condition specification information formed from a plurality of element information items; information processing execution means capable of performing information processing whose details are specified by the processing condition specification information stored in the processing condition specification information storage means; user interface means capable of enabling a user to select one from the processing condition specification information items stored in a predetermined device in the network and changing element information items forming the processing condition specification information stored in the processing condition specification information storage means to element information items whose details are specified by the user; and rewriting means for rewriting the processing condition specification information stored in the processing condition specification information storage means to processing condition specification information selected by the user when the user has selected a certain processing condition specification information item stored in the predetermined device by utilization of the user interface.

Specifically, the information processing apparatus of the present invention has a configuration which utilizes a nonvolatile storage device of another apparatus (a predetermined apparatus in a network) for storing processing condition specification information. Accordingly, despite being able to operate under registered conditions, the information processing apparatus of the present invention can be said to be an apparatus which can be manufactured less inexpensively than the existing apparatus, by the amount stemming from obviation of a necessity for providing the information processing apparatus with a large-capacity nonvolatile storage medium.

When the information processing apparatus of the present invention is implemented, the information processing execution means is preferably embodied as means for storing the processing condition specification information stored in the processing condition specification information storage means when information processing is performed. Moreover, the information processing execution means is preferably provided as means which acts after the user has input identification information thereof by utilization of the user interface means, and as means for storing the processing condition specification information stored in the processing condition specification information in the predetermined device in association with user identification information input at that point in time. The reason for this is that, so long as the information processing apparatus is embodied as such means, the information processing apparatus can be realized as an apparatus which obviates an operation for storing the processing condition specification information in a predetermined device.

The following device can be used as a predetermined device for use with the information processing apparatus of the present invention. Namely, the predetermined device comprises: storage means for storing a plurality of processing condition specification information items in a pattern so as to be distinguishable according to date and hour information; and processing condition specification information number adjustment means which changes date and time information to be used for identifying the processing condition specification information to a current date and time when processing condition specification information to be stored in the storage means is given by the information processing execution means of the information processing apparatus and processing condition specification information whose details are identical with those of the processing condition specification information given by the information processing execution means are present in the processing condition specification information stored in the storage means; and which, when such information is not present in the processing condition specification information stored in the storage means, stores the processing condition specification information in a pattern so as to be distinguished by data and time information representing a current date and time.

To solve the problem, the present invention provides an information processing system in which a plurality of information processing devices and a management device are connected to a network, comprising: information storage means formed from a plurality of element information items, as the management device; and, as the respective information processing devices, processing condition specification information storage means for storing processing condition specification information formed from the plurality of element information items; information processing execution means capable of performing information processing specified by the processing condition specification information stored in the processing condition specification information storage means; user interface means capable of prompting a user to select one from processing condition specification information items stored in information storage means of the management device and changing the respective element information items forming the processing condition specification information stored in the processing condition specification information storage means to element information items specified by the user; and rewrite means for rewriting the processing condition specification information stored in the processing condition specification information means to processing condition specification information selected by the user when the user has selected a certain processing condition specification information item stored in the management device by utilization of the user interface means.

In the information processing system of the present invention having such a configuration, the processing condition specification information can be utilized by the respective information processing devices forming the system, so long as the processing condition specification information items are stored in the management device (information storage means). Accordingly, the information processing system acts as a system which enables easy performance of operation corresponding to registration of the processing conditions in the respective information processing devices.

When the information processing system of the present invention is realized, the information storage means of the management device is preferably embodied as means capable of storing a plurality of processing condition specification information items according to the identification information about a user and of selecting one processing condition specification information item from the processing condition specification information items stored in the management device in association with the identification information after the user has input his/her identification information.

The information processing execution means of the information processing apparatus is taken as means which functions after the user has input his/her identification information by utilization of the user interface means and as (write) means for storing the processing condition specification information stored in the processing condition specification information storage means in processing condition specification information storage means of the management device in association with the identification information about the user input at that point in time. As a result, there can be realized an information processing system which obviates a necessity for intentionally registering the processing condition specification information in the management device. When means for storing the processing condition specification information in the processing condition specification information storage means is adopted as the information processing execution means of the information processing device, the information processing apparatus preferably further comprises processing condition specification information number control means for controlling, to a predetermined number or less for each user identification information item, the number of processing condition specification information items stored in the information storage means associated with the identification information.

The present disclosure relates to the subject matter contained Japanese patent application Nos. 2004-007248 and 2004-007249 (filed on Jan. 14, 2004), each of which is expressly incorporated herein by reference in its entirety.

### BRIEF DESCRIPTION OF THE DRAWINGS

FIG. 1 is a descriptive view showing the configuration and usage status of a digital multifunction machine according to an embodiment of the present invention.

FIG. 2 is an external view of the digital multifunction machine.

FIG. 3 is a block diagram of the digital multifunction machine.

FIG. 4 is an external view of a control unit included in the digital multifunction machine.

FIG. 5 is a descriptive view of scan data transmission processing performed by an information processing system.

FIG. 6 is a descriptive view of a copy basic screen displayed by the control unit.

FIG. 7 is a descriptive view of a user selection screen displayed by the control unit.

FIG. 8 is a descriptive view of a scan basic screen displayed by the control unit.

FIG. 9 is a descriptive view of a scan destination selection screen displayed by the control unit.

FIG. 10 is a descriptive view of a scan destination confirmation/deletion screen displayed by the control unit.

FIG. 11 is a descriptive view of a file format selection screen displayed by the control unit.

FIG. 12 is a descriptive view of an original document type selection screen displayed by the control unit.

FIG. 13 is a descriptive view of a job memory selection screen displayed by the control unit.

FIG. 14 is a descriptive view of the job memory selection screen displayed by the control unit.

FIG. 15 is a descriptive view of information stored in a scan agent computer included in the information processing system.

FIG. 16 is a descriptive view of information stored in the scan agent computer.

FIG. 17 is a flowchart showing IP address registration/confirmation processing performed by the scan agent computer.

FIG. 18 is a scan user setting page provided by the scan agent computer.

FIG. 19 is a descriptive view of a job memory setting page provided by the scan agent computer.

FIG. 20 is a descriptive view of a folder setting page provided by the scan agent computer.

FIG. 21 is a descriptive view of a destination setting page provided by the scan agent computer.

FIG. 22 is a descriptive view of a destination group setting page provided by the scan agent computer.

FIG. 23 is a sequence chart showing operation procedures of the information processing system.

FIG. 24 is a sequence chart showing the operation procedures of the information processing system.

FIG. 25 is a sequence chart showing the operation procedures of the information processing system.

### DESCRIPTION OF THE PREFERRED EMBODIMENT

A best mode for implementing the present invention will be described in detail hereunder by reference to the drawings.

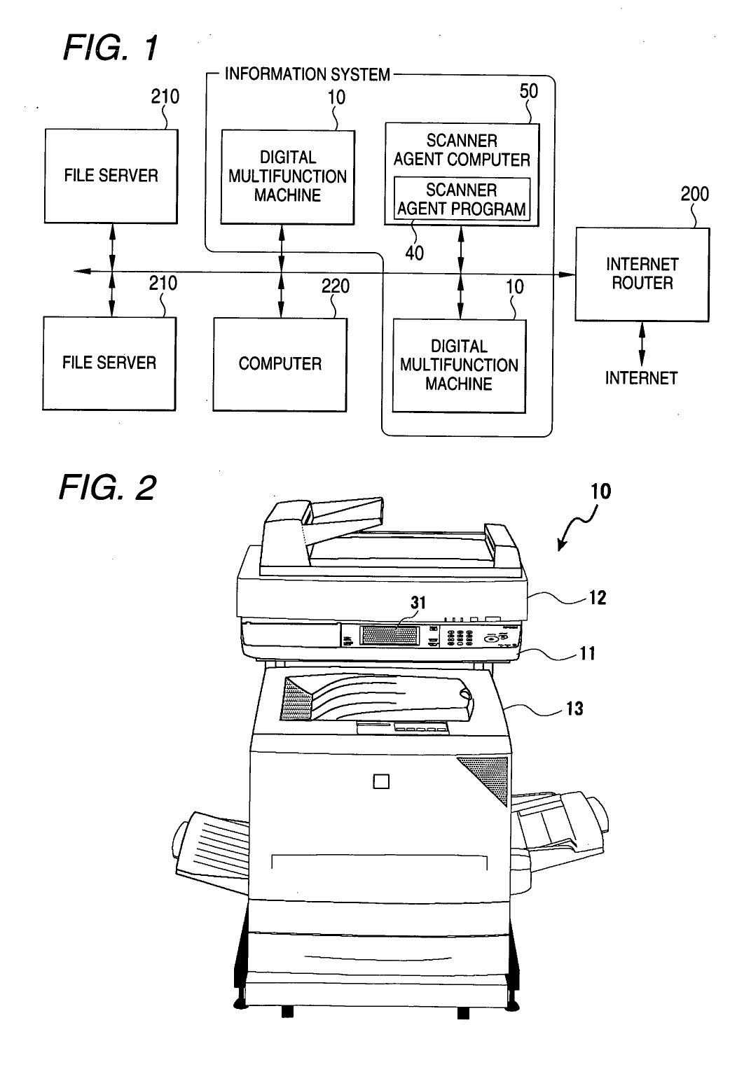

The configuration and usage pattern of a digital multifunction machine 10 which is an embodiment of the information processing apparatus of the present invention will be described by reference to FIGS. 1 through 4. The configuration of an information processing system which is another embodiment of the present invention will also be described with reference to FIGS. 1 through 4.

As shown in FIG. 1, the digital multifunction machine 10 of the present embodiment is configured as being used along with other digital multifunction machines 10 while being connected to a network comprising a scan agent computer 50, an internet router 200, file servers 210, some computers 220 (one of which is shown in the drawings), etc.

The scan agent computer 50 is a computer installed with a scan agent program 40 developed for use with the digital multifunction machine 10 and/or the information processing system. Although the function of the scan agent program 40 will be described later, the scan agent program 40 requires setting of an administrator's name and a password, a work folder, and setting of a mail server when installed (setup). A system—in which this scan agent computer (corresponding to a management apparatus or device) 50 and at least one (two, in FIG. 1) digital multifunction machine (corresponding to an information processing apparatus or device) 10 are connected by way of a network—corresponds to the information processing system according to the present invention. The information processing system is connected to the network comprising the internet router 200, some file servers 210, some computers 220 (one of which is shown in the drawings), etc.

The internet router 200 on the network to which the information processing system is connected is a device for connecting the computers 220 to the Internet. The file server 210 is a computer in which a shared folder is set. The computer 220 is a computer (a computer installed with a Web browser) used by an administrator of the information processing system or a common user.

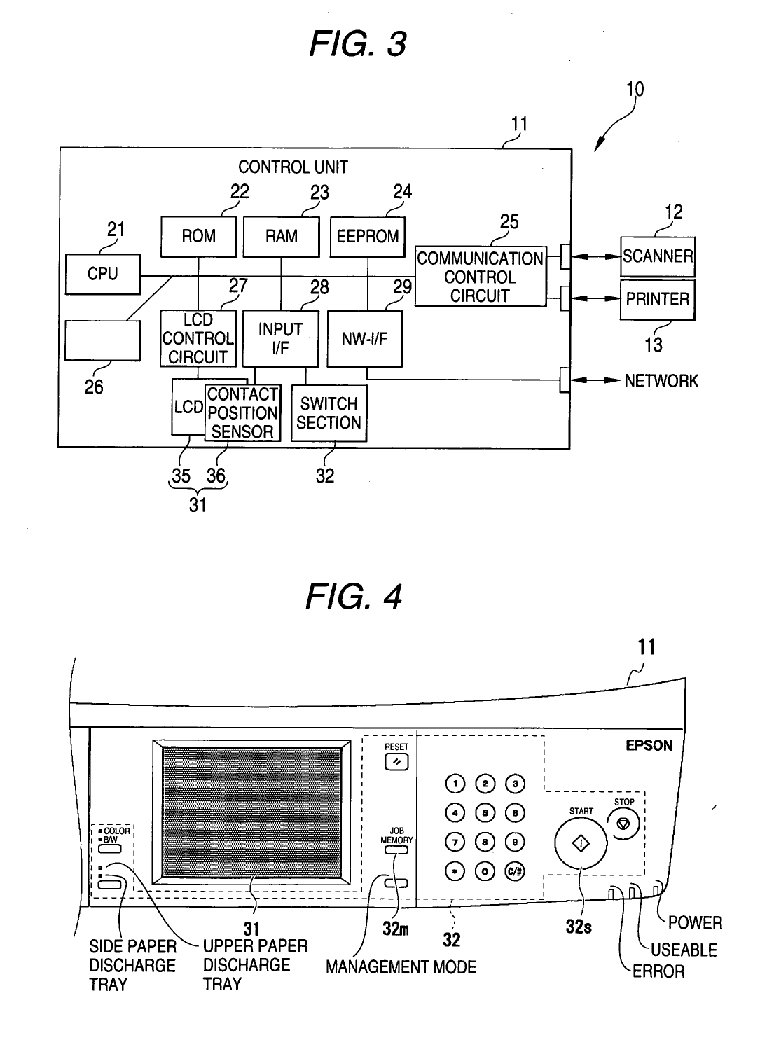

The digital multifunction machine 10 is an apparatus which has an appearance and a hardware configuration such as those shown in FIGS. 2 and 3. Specifically, the digital multifunction machine 10 is an apparatus formed by combination of a control unit 11, a scanner 12, and a printer 13 so as to assume the same appearance as that of a common digital multifunction machine/copier (see FIG. 2).

The printer 13 used in this digital multifunction machine 10 is an apparatus realized by providing a printer-which can be used as a peripheral device of the computer—with an expansion board for configuring the digital multifunction machine 10 (for connecting the control unit 11 to the printer 13). The scanner 12 is a device realized by providing a scanner which can be used as a peripheral device of a computer with an expansion board for configuring the digital multifunction machine 10 (for connecting the control unit 1I1 to the scanner 12).

As shown in FIG. 3, the control unit 11 is a unit configured of a CPU 21, ROM 22, RAM 23, EEPROM 24, a communication control circuit 25, an image processing circuit 26, an LCD control circuit 27, an input interface circuit (input I/F) 28, a network interface circuit (NW-I/F) 29, a touch screen 31, a switch section 32, and the like.

The touch screen 31 used in this control unit 11 is an element formed by superimposing a transparent contact position sensor 36 on a liquid-crystal display (LCD) 35. As shown in FIGS. 2 and 4, the touch screen 31 is provided on a housing of the control unit 11. The switch section 32 (see FIGS. 3 and 4) is a ulit formed from a job memory button 32m provided on the housing of the control unit 11, a start button 32s, various press button switches such as ten-keys, and a control circuit of these buttons and switches.

The CPU 21 (FIG. 3) is a control circuit for controlling individual sections of the digital multifunction machine 10 (individual portions in the control unit 11, the scanner 12, and the printer 13) in a unified manner. The ROM 22 is read-only memory where are recorded a program for specifying operation procedures of the CPU 21 and data to be utilized by the CPU 21 (a program). The RAM 23 is memory into which the program recorded in the ROM 22 is read and which is used as a work area of the CPU 21 (the program). The communication control circuit 25 is a circuit used by the CPU 21 for exchanging information to and from the scanner 12 or the printer 13 (e.g., transmission of a command, receipt of image data, and transmission of print data).

The LCD control circuit 27 is a circuit for displaying an image (screen) instructed by the CPU 21 on the touch screen 31 (the LCD 35). The input interface circuit 28 is a circuit for notifying the CPU 21 about details of operation of the ten-key section 32 or operation of the touch screen 31 (the contact position sensor 36) performed by the user (an operator of the digital multifunction machine 10). The network interface circuit 29 is a circuit for connecting the control unit 11 to the network.

The EEPROM 24 is nonvolatile rewritable memory which is mounted on the control unit 11 for storing various types of information items (a device IP address, an agent IP address, or the like, which will be described later) required to be retained even after power has been cut.

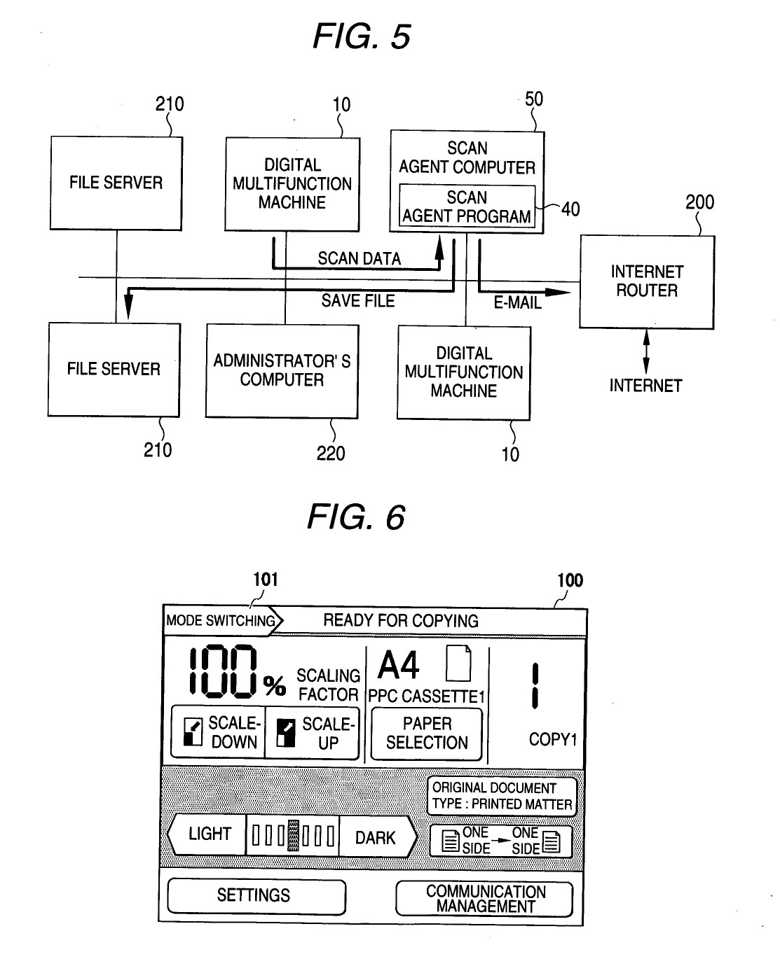

Operation procedures of the information processing system (virtual operation of the control unit 11) according to the embodiment will now be descried by reference to FIGS. 5 to 14.

The control unit 11 has an operation mode (hereinafter described as a “copy mode”) for activating the digital multifunction machine 10 as a copier and an operation mode (hereinafter described as a “scan mode”) for activating, as a system capable of performing scan data transmission processing, a system comprising the digital multifunction machine 10 and the scan agent computer 50.

Here, the scan data transmission processing is processing wherein either scan-to-mail processing or scan-to-file processing or both of them are performed. As schematically shown in FIG. 5, the scan-to-mail processing is processing in which scan data (image data pertaining to an original document generated by the scanner 12) are transmitted from the digital multifunction machine 10 to the scan agent computer 50; and in which the scan agent computer 50 having received the scan data sends an E-mail attached with a file of the scan data to addresses specified by the user. The scan-to-file processing is processing in which the scan data are transmitted from the digital multifunction machine 10 to the scan agent computer 50; and in which the scan agent computer 50 having received the scan data stores a file of scan data into several locations specified by the user (any of the shared folders within the file server 210).

63 During the scan data transmission processing where both the scan-to-mail processing and the scan-to-file processing are performed, both processing operations are performed on the basis of the same scan data. The scan data transmission processing is processing which is commenced when the start button 32s (FIG. 4) provided on the control unit 11 is pressed.

When the control unit 11 is operating in a copy mode, a copy basic screen 100 shown in FIG. 6 is usually displayed on the touch screen 31.

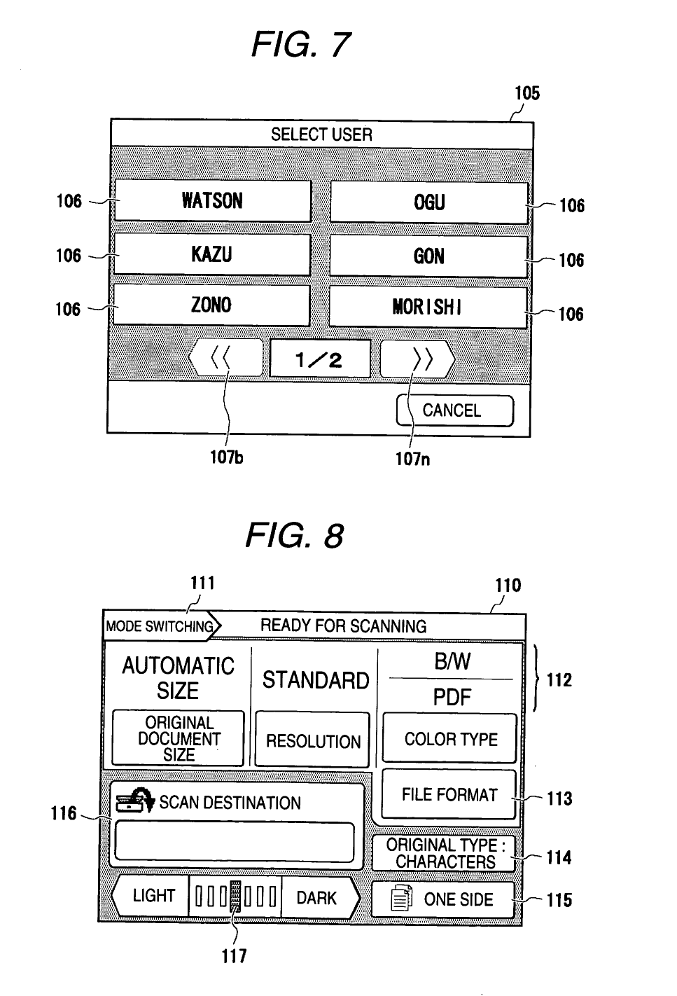

When the control unit 11 is desired to start operation in a scan mode (when the information processing system is desired to perform scan data transmission processing), the user presses a mode switching button 101 provided on the copy basic screen 100. When this operation is performed, the control unit 11 starts operation in the scan mode. A user selection screen 105 such as that shown in FIG. 7 is displayed on the touch screen 31.

The user presses a user name button 106 on which is displayed a user's name (a name registered in the information processing system; e.g., WATSON) and which is provided on the user selection screen 105. When the user name button 106 pertaining the user is not present in the displayed user selection screen 105, the user presses a button 107n. When the user has pressed the button 107n, there is displayed a user selection screen 105 having the user name button 106 pertaining to another registered user, a valid button 107b, and an invalid button 107n (displayed in a hatched manner and nothing is performed even when this button is pressed). Hence, the user presses the user name button 106 pertaining thereto on the user selection screen 105.

As a result of the user having pressed the user name button 106 pertaining thereto, a scan basic screen 110 shown in FIG. 8 is displayed on the touch screen 31 when the user is not the person who has set the password [details will be described later for the case where the pressed user name button 106 pertains to the user whose password is registered (set)]. In the meantime, when the user is the person who has set the password, the password (four digits) coinciding with the registered password is input by the user, the scan basis screen 110 shown in FIG. 8 is displayed.

The scan basis screen 110 is a screen on which are displayed default processing detail specification information (corresponding to an aggregate of setting values which define details other than a destination for scan data transmission processing) stored in RAM (corresponding to processing condition specification information storage means).

A mode switching button 111 on the scan basis screen 110 is a button which causes the control unit 11 to start operation in a copy mode when pressed.

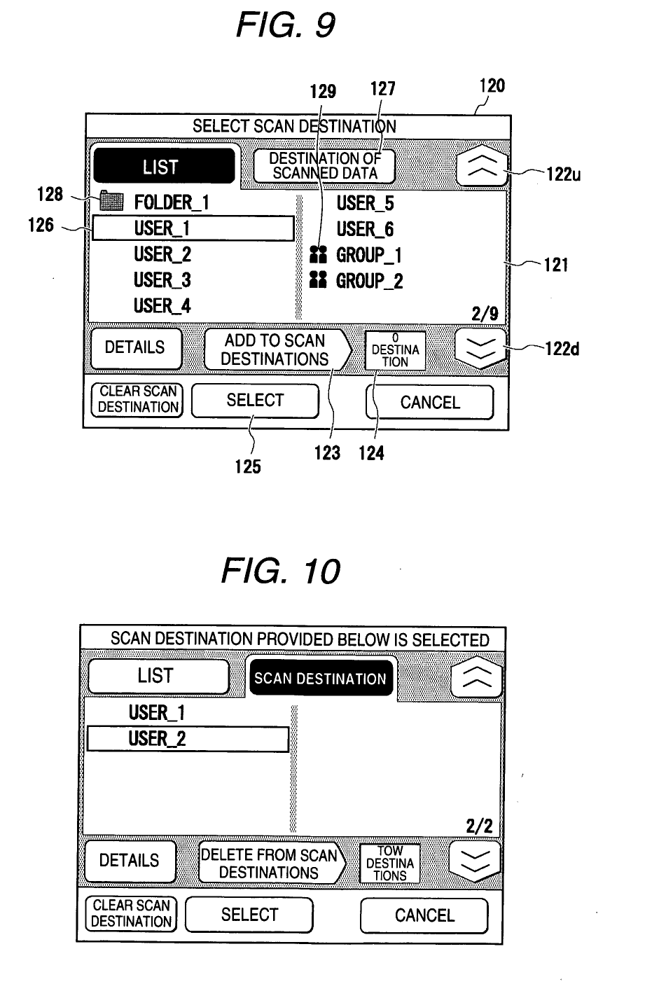

When a scan destination button 116 is pressed, a scan destination selection screen 120 shown in FIG. 9 is displayed on the touch screen 31.

A list area 121 of the scan destination selection screen 120 is an area where is displayed the designation of each transmission destination information item registered in advance by the user (“FOLDER_{—}1,” “USER_{—}1,” or the like; hereinafter also described as a “designation of transmission destination specification information”). A method for setting transmission destination specification information will be described later. The information processing system is constituted as a system capable of registering, as transmission destination specification information, transmission destination specification information for scan-to-file processing (including a folder path; hereinafter described as “transmission destination specification information for storage purpose”), transmission destination specification information for scan-to-mail processing including one mail address (hereinafter described as “mail transmission destination specification information”), and transmission destination specification information for scan-to-mail processing including a plurality of mail addresses (hereinafter described as “group transmission destination specification information”). As is evident from FIG. 9, an icon 128 and a designation thereof (FOLDER_1) are displayed in the list area 121 of the scan destination selection screen 120 in connection with each transmission destination specification information item for storage purpose. In connection with each mail transmission destination specification information, only the designation of the information (“USER_{—}1” or the like) is displayed in the list area 121. In connection with each group transmission destination specification information item, an icon 129 and a designation thereof (“GROUP_{—}1” or the like) are displayed in the list area 121.

The scan destination selection screen 120 is a screen which enables selection of an arbitrary number of transmission destination specification information items by means of the following operation.

Specifically, when the user desires to select a certain transmission designation specification information item, there is provided a state in which a selection frame 126 appears on an area where is displayed the designation of transmission destination information item desired to be selected, by means of operating a button 122u and a button 122d. To complete selection, the user presses an “add-to-scan-destinations” button 123.

When the user has pressed the “add-to-scan-destinations” button 123, the control unit 11 stores the fact that the transmission destination specification information item identified by the designation of transmission destination specification information enclosed by the selection frame 126 has been selected. The control unit 11 increments a numeral in a selected destination display field 124 by one and deletes the designation of transmission destination specification information item enclosed by the selection frame 126 from the list area 121.

When a plurality of transmission destination specification information items are selected, the user presses a “select” button 125 after having performed the foregoing operation for each transmission destination specification information item. A scan destination button 127 on the scan destination selection screen 120 is a button which causes a scan destination confirmation/deletion screen shown in FIG. 10 to appear on the touch screen 31 when pressed. Hence, when the user desires to ascertain the selected transmission destination specification information item(s), the user displays this scan destination confirmation/deletion screen and presses the “select” button (or the “select” button 125 on the scan destination selection screen 120) on the scan destination selection confirmation/deletion screen.

When the user has pressed the “select” button 125 (or the “select” button on the scan destination confirmation/deletion screen), the scan basic screen 110 appears on the touch screen 31, wherein information about the transmission destination specification information selected by the user is displayed within the scan destination button 116 on the scan basic screen 110.

Turning again to FIG. 8, descriptions of the scan basic screen 110 are continued.

A setting value area 112 provided on the scan basic screen 110 is an area where there are displayed the size of an original document, a resolution, a color type, and a file format, all being achieved at this point in time. An “original size” button, a “resolution” button, a “color type” button, and a “file format” button 113 are for changing setting values pertaining to an original document size, a resolution, a color type, and a file format.

An “original document type” button 114 is for specifying the type of an original-document (the document corresponds to any one of a piece of printed matter, a photograph, and a document in which the majority of content is formed from characters). This “original document type” button 114 is a button in which a setting value (characters in the drawing) achieved at that point in time is displayed. A one side/double side switching button 115 is also formed as a button in which a setting value (one side in the drawing) achieved at that point in time is displayed.

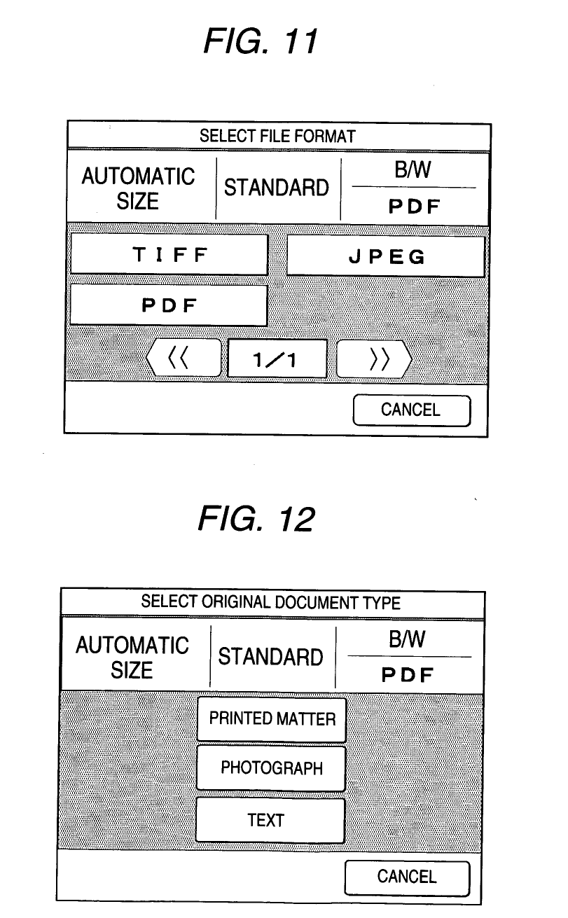

All of these buttons are displayed in the form of other screens on the touch screen 31 when pressed. For instance, the file format button 113 is formed as a button which causes a file format selection screen such as that shown in FIG. 11 to appear on the touch screen 31 when pressed. The original document type button 114 is formed as a button which causes an original document type selection screen shown in FIG. 12 to appear on the touch screen 31 when pressed.

A “light” button and a “dark” button, which are to be used for controlling the density of a scan, are formed as buttons which do not cause another screen to appear when pressed (i.e., buttons which cause the display position of a density cursor 117 to move when pressed).

In short, the information processing system is arranged so as to be able to start scan data transmission processing when the start button 32s is pressed after various settings have been performed by utilization of the scan basic screen 110.

When performing scan data transmission processing whose file generation conditions (conditions other than a scan destination) are the same as those of the scan data transmission processing performed in the past, the information processing system also obviates the necessity for the user to operate the “paper size” button or the like on the scan basic screen 110.

Specifically, in this case, the user displays the scan basic screen 110 and then presses the job memory button 32m (FIG. 4).

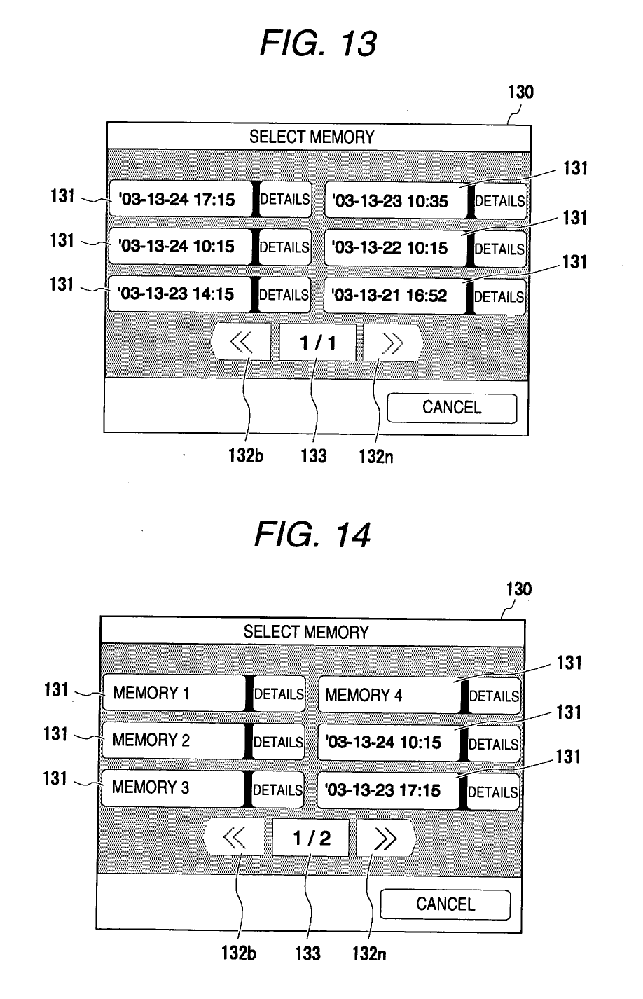

When the user presses the job memory button 32m, a job memory selection screen 130, such as that shown in FIGS. 13 and 14, is displayed on the touch screen 31.

Respective buttons 131—in which a date and time are displayed and which are displayed on the respective job memory selection screens 130 shown in the drawings—are buttons (hereinafter also described as “history buttons 131”) associated with information (an aggregate of information items which can be set by pressing buttons on the scan basic screen 110 other than the scan destination button 116; and hereinafter described as “processing details specification information”) showing details of the scan data transmission processing which the user caused the information processing system to perform in the past. The button 131—in which is displayed “display 1” and which is provided on the job memory selection screen 130 (hereinafter also described as a “setting memory button 131”) is associated with the processing details specification information set by the administrator.

This information processing system is arranged such that, when a certain button 131 on the job memory selection screen 130 (the history button 131 or the setting memory button 131) is pressed, the scan basic screen 110—on which are reflected details of the processing detail specification information associated with the button 131—is displayed on the touch screen 31.

Operation of the information processing system will be described in more detail on the premise of the foregoing descriptions.

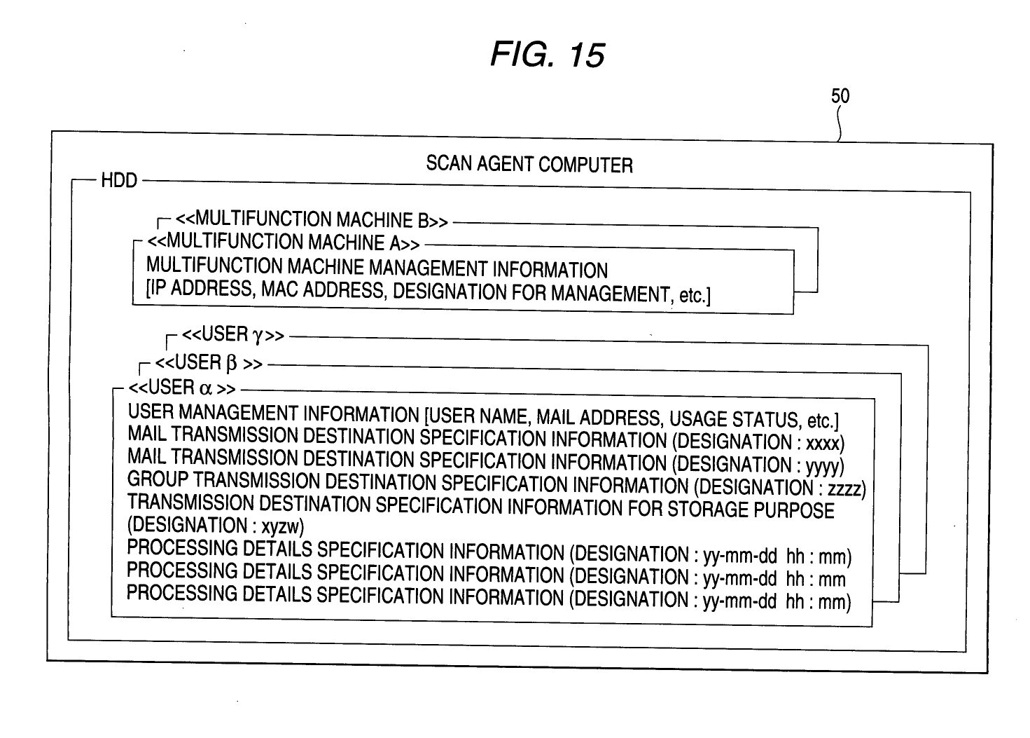

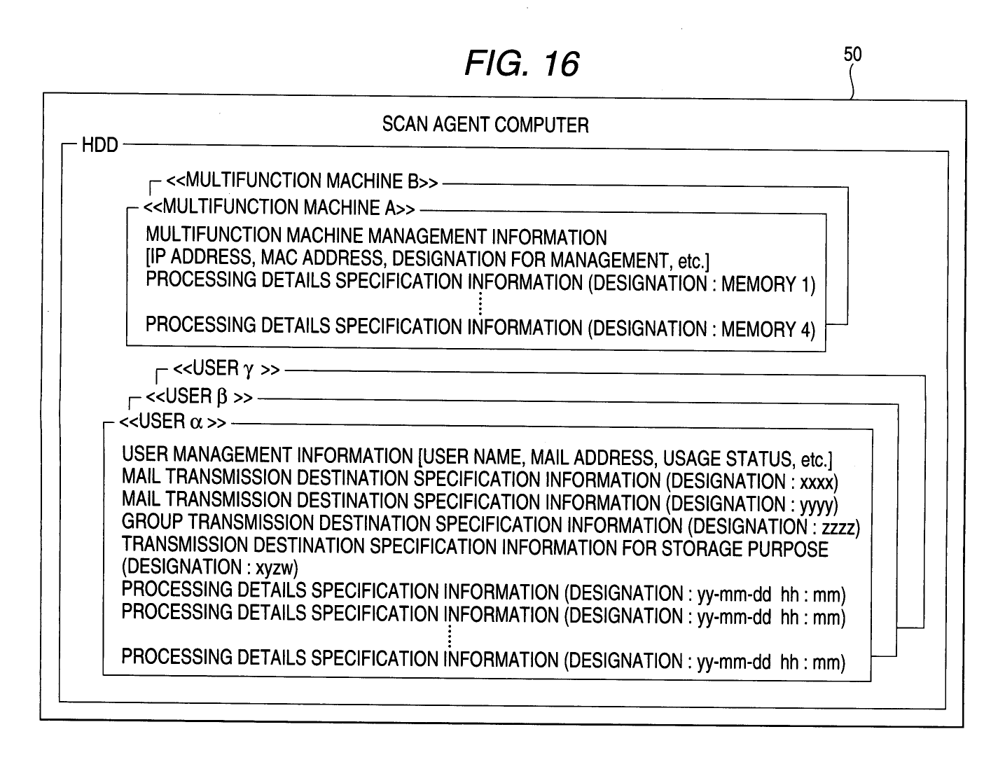

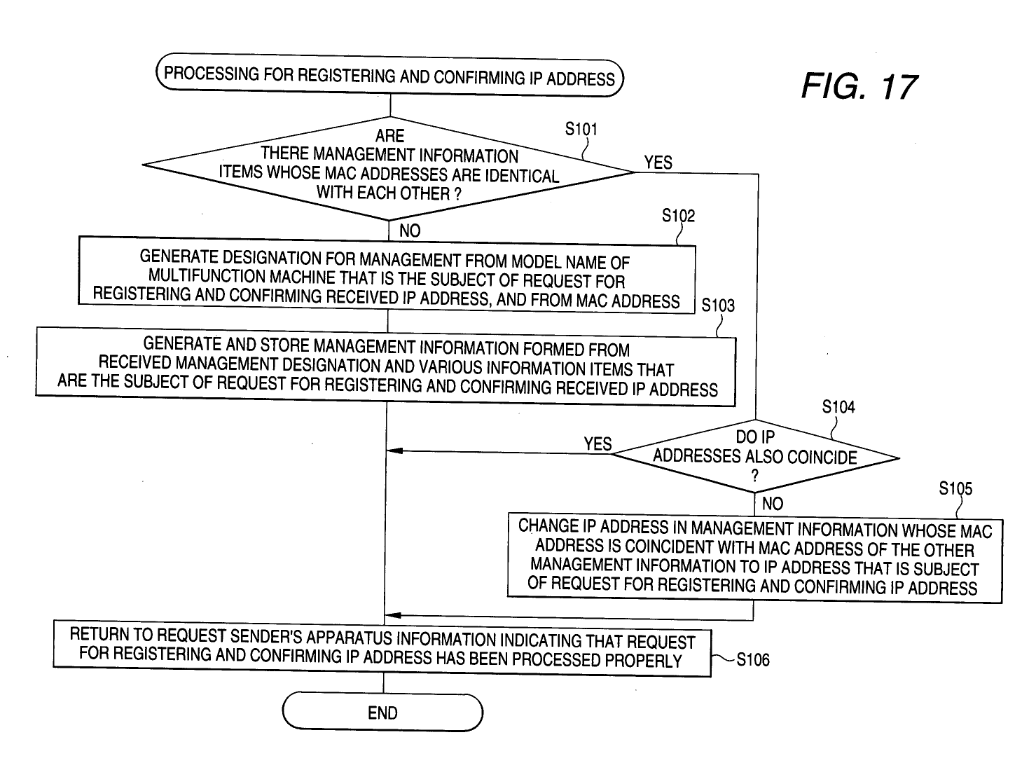

In the information processing system, the above-described processing details specification information and the transmission destination specification information are stored in such a pattern as schematically shown in FIGS. 15 and 16 in an HDD of the scan agent computer 50.

Specifically, in the information processing system, multifunction machine management information, or multifunction machine management information and some processing details specification information items are stored in the IDD of the scan agent computer 50 as well as in the digital multifunction machine 10. The system operates with user management information, the transmission destination specification information, and the processing details specification information being stored for each user.

The multifunction machine management information about the respective digital multifunction machines 10 (the multifunction machines A and B in the drawing) stored in the scan agent computer 50 is formed from an IP address, a MAC address, a designation for management purpose, or the like, all pertaining to a corresponding digital multifunction machine 10. The multifunction machine management information is automatically registered in the scan agent computer 50 when the digital multifunction machine 10 is subjected to initial setting.

Specifically, the control unit 11 is formed as a unit which must perform an operation for assigning an IP address (hereinafter described as a “device IP address”) to the control unit 11 when mounted (when built in the network) and operation for storing an IP address (hereinafter described as an “agent IP address”) assigned to the agent computer 50. The control unit 11 is configured such that the device IP address and the agent IP address, both having been set through the foregoing operations, are stored in the EEPROM 24 so that the operations can be performed by operating the ten-keys and the touch screen 31 on the control unit 11.

The control unit 11 is also configured as follows. When power is turned on while the device IP address and the agent IP address are stored in the EEPROM 24 and when the device IP address or the agent IP address has been changed, the control unit transmits an IP address registration/confirmation request formed from information, the information comprising a device IP address, a MAC address of a unit of interest (the network interface circuit 29), the model name of the unit of interest, the model name of the scanner 12, and a mount status of an optional device (ADF) of the scanner 12.

In the meantime, the scan agent program 40 is for causing the scan agent computer 50 having received the IP address registration/confirmation request to perform the IP address registration/confirmation operation having the procedures shown in FIG. 17.

Specifically, the scan agent computer 50 having received the IP address registration/confirmation request determines whether or not multifunction machine management information corresponding to the IP address registration/confirmation request is stored in itself (i.e., a predetermined folder in the HDD of the computer) (step S101). Here, the multifunction machine management information corresponding to the received IP address registration/confirmation request includes a MAC address identical with that included in the received IP address registration/confirmation request.

When the multifunction machine management information corresponding to the received IP address registration/confirmation request is not stored in itself (when NO is selected in step S101), the scan agent computer 50 generates a designation for management purpose by combining the model name of the control unit 11 included in the IP address registration/confirmation request with a portion of the MAC address (step S102). The scan agent computer 50 then generates multifunction machine management information including the thus-generated designation for management and various information items included in the received IP address registration/confirmation request and stores the thus-generated information in itself (step S103). The processing to be actually performed in step S 102 is for generating a character string by appending the last four letters of the MAC address to the model name of the control unit 11. Processing to be actually performed in step S103 is for preparing a folder having the same designation as that of the MAC address below a predetermined folder prepared in the HDD, and preparing a file of multifunction machine management information in the thus-prepared folder.

The scan agent computer 50 having finished generation and storage of the multifunction management information (step S103) returns information indicating that the IP address registration/confirmation request has been processed normally to a device that is the sender of the IP address registration/confirmation request (the digital multifunction machine 10/the control unit 11) (step S106). The scan agent computer 50 completes the IP address registration/confirmation processing.

When the multifunction machine management information corresponding to the received IP address registration/confirmation request is stored in the computer of interest (when YES is selected in step S101), the scan agent computer 50 determines whether or not the device IP address included in the multifunction machine management information coincides with the device IP address included in the received IP address registration/confirmation request (step S104). When a coincidence exists between the 1P addresses (when Yes is selected in step S104), the scan agent computer 50 performs processing in step S106. When no coincidence exists between the IP addresses (when NO is selected in step S104), the scan agent computer 50 performs processing in step S106 after having changed, to the device IP address included in the IP address registration/confirmation request, the device IP address in the multifunction management information whose MAC address coincides with that of the received IP address registration/confirmation request but whose IP address does not coincide with the device IP address (step S105).

Turning again to FIGS. 15 and 16, description of the information stored in the scan agent computer 50 is continued.

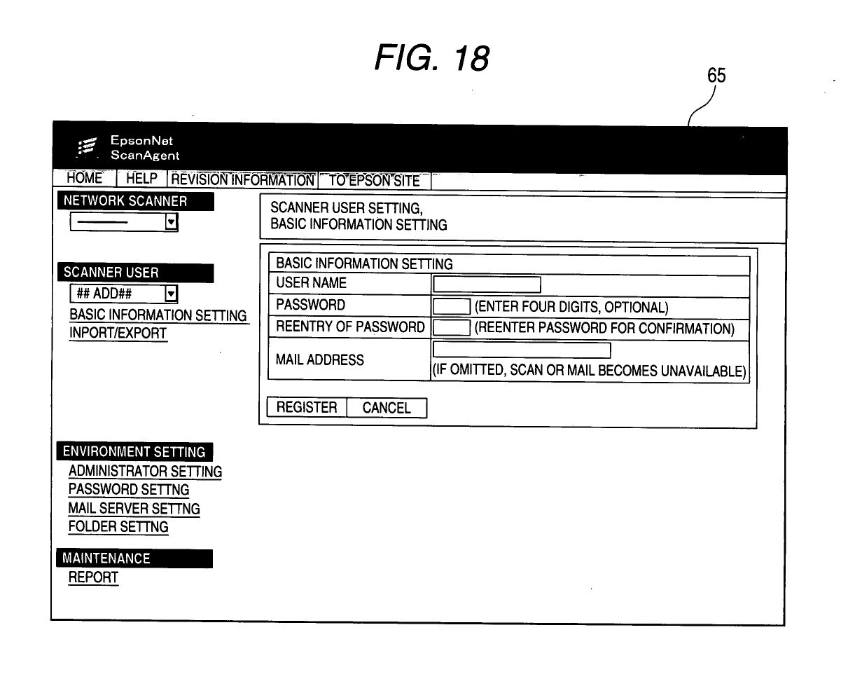

The scan agent computer 50 provides the user management information stored for each user in the scan agent computer 50. This information corresponds to the information (information formed from a user name, a mail address, and a password) set through use of a scan user setting page 65 shown in FIG. 18. The scan user setting page 65 corresponds to a Web page which can be displayed after a log-in has been performed with use of an administrator's name and a corresponding password. Specifically, the user management information becomes information to be set by the administrator.

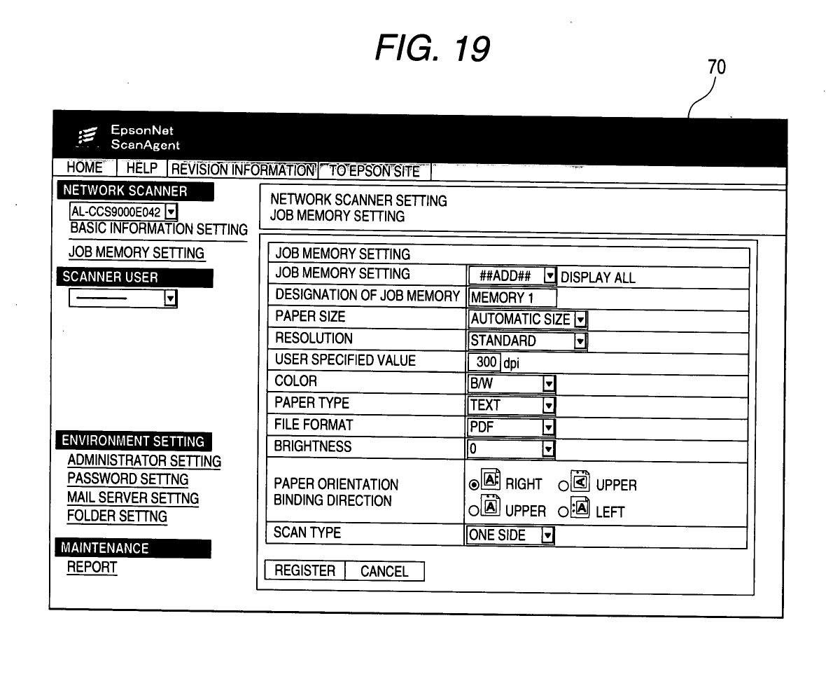

The processing details specification information about each digital. multifunction machine 10 stored in the scan agent computer 50 is the information that is provided by the scan agent computer 50 and set through use of a job memory setting page 70 shown in FIG. 19. This job memory setting page 70 is also a Web page which can be displayed after the administrator has logged on to the computer by entering name and password.

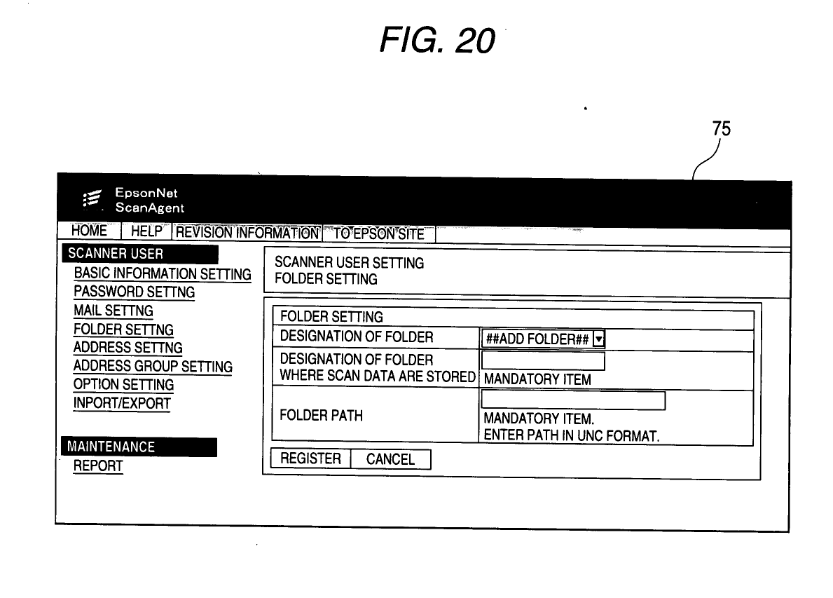

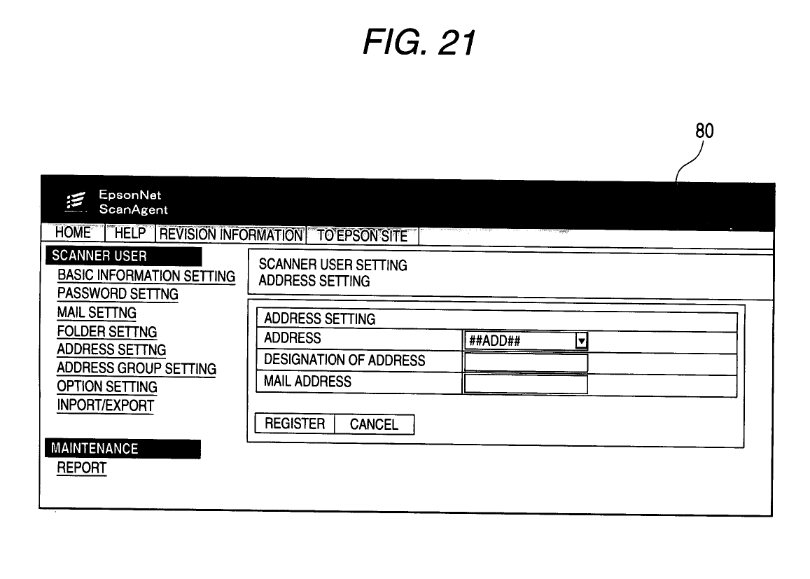

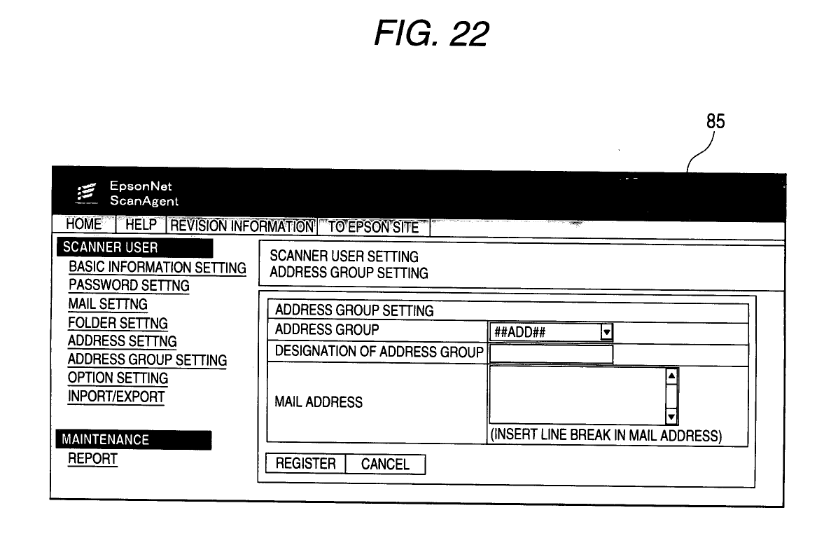

The transmission destination specification information stored for each user in the scan agent computer 50 is information set by the user for which the user management information is set (i.e., registration of the user has been completed) while utilizing a folder setting page 75, an address setting page 80, and an address group setting page 85, which are shown in FIGS. 20 to 22. These setting pages also act as Web pages which can be displayed after the user has logged on to the computer by entering user name and password (or only user name). The information items input by way of the respective setting pages are stored in the HDD of the scan agent computer 50 as information about the user who has logged on to the computer (the transmission destination specification information for storage purpose/the mail transmission destination specification information/the group transmission destination specification information).

The processing details specification information about each digital multifunction machine 10 stored in the scan agent computer 50 is the information used for display of the job memory selection screen 130 (FIGS. 13 and 14), or the like, that has already been performed.

In the information processing system, when an operation has been performed for causing a certain digital multifunction machine 10 (the control unit 11) to start scan data transmission processing, various types of information items stored in the scan agent computer 50 are utilized as follows.

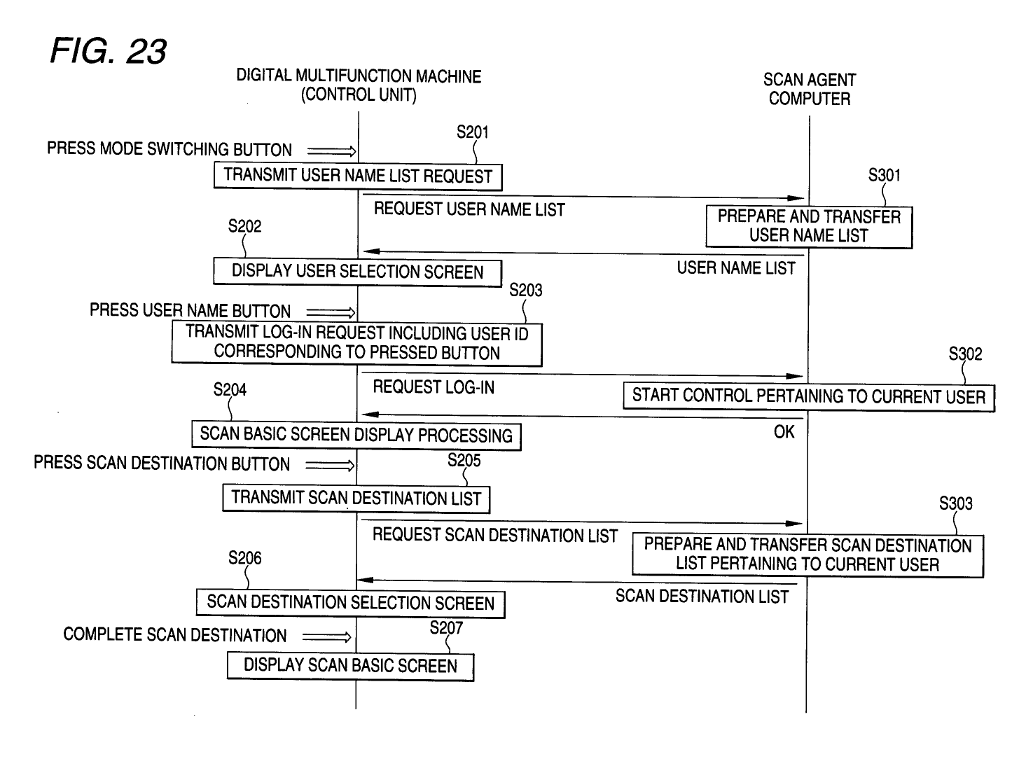

As shown in FIG. 23, when the mode switching button 101 (FIG. 6) has been pressed, the control unit 11 sends the user name list request to the scan agent computer 50 (the device having the agent IP address stored in the EEPROM 24) (S??201??). The information processing system is a system wherein communication between the control unit 11 and the agent computer 50 is performed by means of HTTP (i.e., a system for effecting transmission and receipt of various types of information items between the control unit 11 and the agent computer 50 by means of a request body and response body of the HTTP).

The scan agent computer 50 having received the user name list request prepares a user name list from the group of user management information items stored in itself and returns the thus-generated user name list to the digital multifunction machine 10 (S301). The user name list is information showing the name of an individual user and whether or not the user is the person who has set the password.

The control unit 11 having received the user name list displays, on the touch screen 31, the user selection screen 105 (FIG. 7) having the user name button 106 on which is displayed an individual user included in the user name list (S202).

When a certain user name button 106 on the user selection screen 105 has been pressed, the control unit 11 sends to the scan agent computer 50 a log-in request including a user name corresponding to the pressed user name button 106 (S203). When the pressed user name button 106 pertains to the user who has set the password, the control unit 11 prompts the user to enter the password, by displaying the password input screen on the touch screen 31. The control unit 11 sends the log-in request including the password and the user name, both having been entered by the user, to the scan agent computer 50.

After having confirmed existence of the user management information including the same information (the user name or the user name and the password) as that included in the log-in request, the scan agent computer 50 having received the log-in request starts processing (session management in the drawing) for handling the request from the control unit 11 having sent the log-in request as a request from the user (hereinafter described as the current user) identified by the user name included in the log-in request (S302). Moreover, the scan agent computer 50 returns to the digital multifunction machine 10 the information showing that the log-in request has been received (OK in the drawing).

The control unit 11 having received the information displays the scan basic screen 110 (FIG. 8) on the touch screen 31 (S204). When the scan destination button 116 on the scan basic screen 110 has been pressed, the control unit 11 sends a scan destination list request to the scan agent computer 50 (S205).

The agent computer 50 having received the scan destination list request prepares a scan destination list with regard to each transmission destination specification information stored in the computer 50 in association with the current user, wherein the transmission destination specification information includes the designation of the transmission destination specification information (i.e., the designation of a transmission destination information item) and information as to which one of the transmission destination specification information for storage purpose, the mail transmission destination specification information, and the group transmission destination specification information corresponds to the transmission destination specification information; and returns the thus-prepared information to the control unit 11 (S303).

The control unit 11 having received the scan destination list displays, on the touch screen 31, the scan destination selection screen 120 (FIG. 9) on which are displayed the names of transmission destination specification information items in the scan destination list (S206). When operation for selecting the scan destination (a transmission destination) has been completed (when a “select” button 125 has been pressed, or the like), the scan basic screen 110 appears on the touch screen 31 (S207).

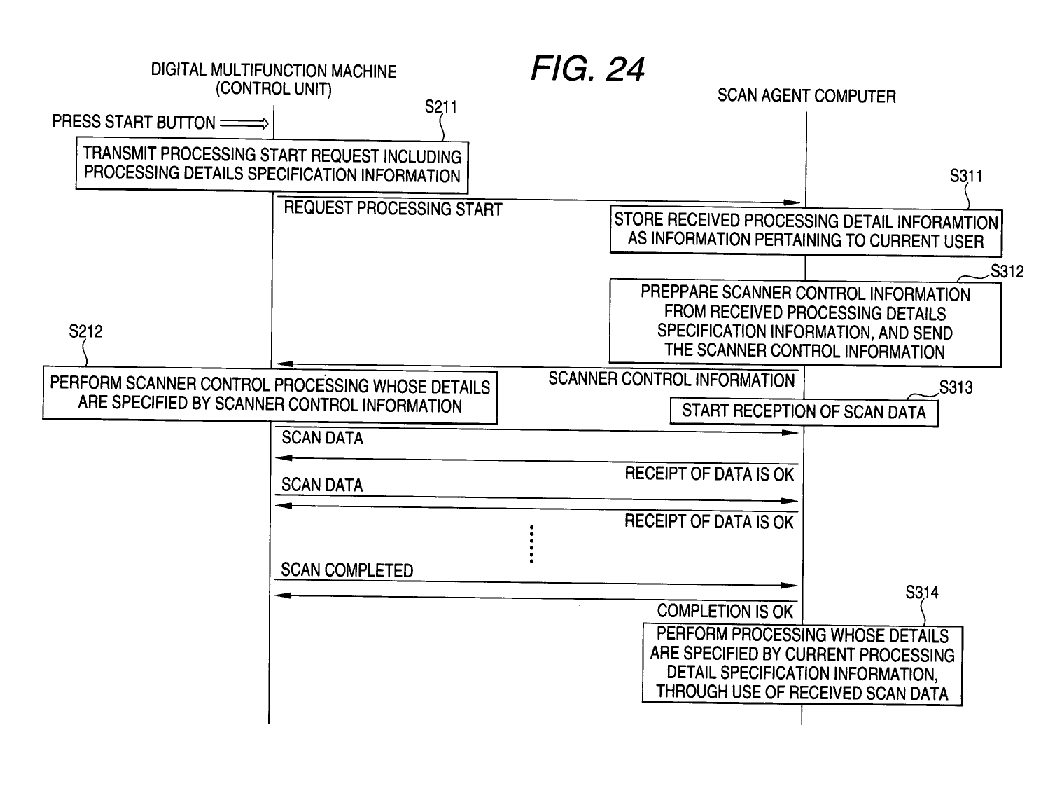

When the start button 32s has been pressed with the scan destination having been set, the control unit 11 transmits, to the scan agent computer 50, a processing start request including processing details specification information (processing details specification information whose details are displayed on the scan basic screen 110) achieved at that point in time, as shown in FIG. 24 (S211).

The scan agent computer 50 having received the processing start request stores (adds to), in the HDD, the processing details specification information included in the processing start request as processing details specification information about a current user having a designation generated from a current date (S311). When the existing processing details specification information pertaining to the current user includes the processing details information (only the designation of the information is different) identical with the current processing details information, the current processing details information is stored in place of the processing detail specification information (i.e., the designation of the existing processing details specification information is changed). In contrast, when the existing processing details specification information pertaining to the current user does not include the processing details information identical with the current processing details information and when the number of existing processing details specification information items pertaining to the current user is a predetermined number, the oldest processing details specification information (the processing details specification information whose designation shows the earliest date) is deleted, and the current processing details specification information is stored.

Subsequently, the scan agent computer 50 prepares scanner control information on the basis of the received processing details specification information and returns the thus-generated information to the control unit 11 (step S312). Here, the scanner control information is information formed by converting each information item in the processing details specification information into information (a command) for controlling the scanner 12.

The control unit 11 having received the scanner control information causes the scanner 12 to perform control processing whose details are specified by the scanner control information (S212); in other words, the control unit 11 causes the scanner 12 to start operation.

The control unit 11 enters a state in which the scan data transmitted from the scanner 12 are transferred to the scan agent computer 50.

The scan agent computer 50 having returned the scanner control information to the control section 11 receives the scan data transmitted from the control section 11 and commences operation for storing the data in the HDD (S313). When the information indicating completion of transmission of all scan data (completion of scan in the drawing) has been transmitted from the control section 11, the scan agent computer 50 performs operations specified by the current processing details specification information (the processing details specification information included in the processing start request) through use of the scan data having already finished being received (S314). Namely, the scan agent computer 50 performs operations for preparing a file from scan data in a specified file format and transmitting the thus-prepared file to a destination (the shared folder of the file server 210 or a mailbox).

Processing pertaining to S314 is described as follows. When a specified file format is TIFF and a specified color type is B/W, an M (G4)-compressed TIFF file is prepared. When the specified file format is TIFF and the specified color type is color or grayscale and when the scan destination (a location where files are to be stored) is a shared folder, a non-compressed TIFF file is prepared. When the specified file format is TIFF and the specified color type is color or grayscale and when the scan destination (the location where files are to be stored) is a mailbox, a JPEG-compressed TIFF file is prepared.

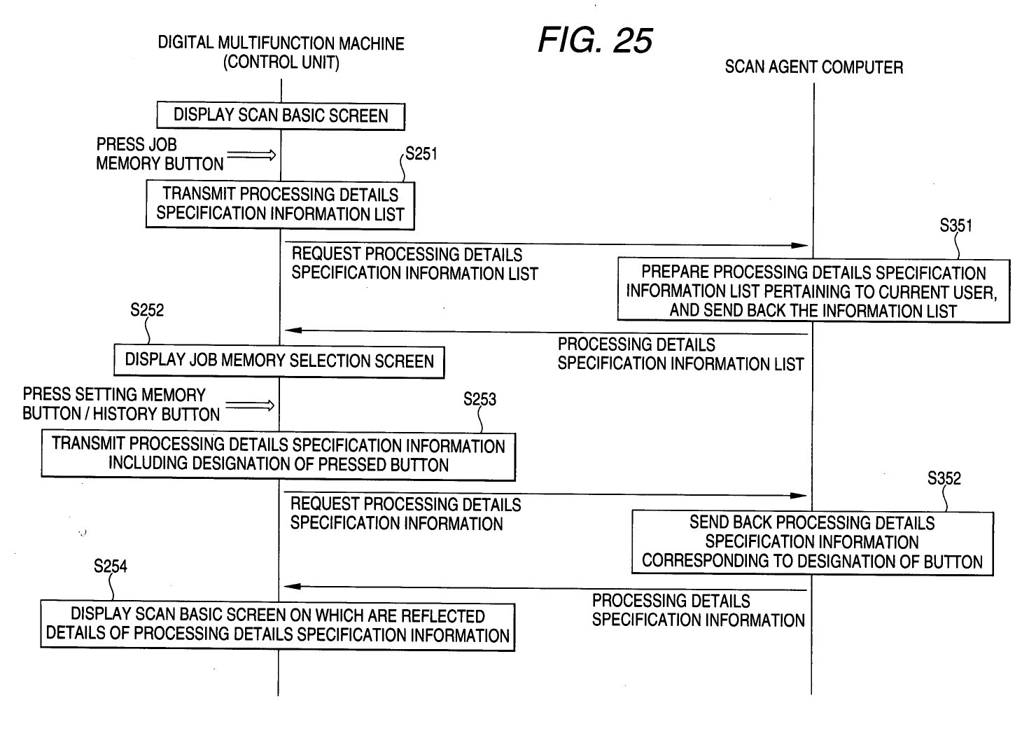

When the job memory button 32m is pressed with the scan basic screen 110 being displayed, the control unit 11 operates as shown in FIG. 25.

Specifically, the control unit sends a processing details specification information list request to the scan agent computer 50 (S251).

The scan agent computer 50 having received the processing details specification information list request prepares a processing details specification information list pertaining to the current user and returns the thus-prepared list to the control unit 11 (S351). The processing details specification information list pertaining to the current user is information including the designation of respective processing details specification information items (the processing details specification information registered by the administrator) stored in the computer 50 in association with the digital multifunction machine 10 having transmitted the processing details specification information list request and the designation of respective processing details specification information items stored in the computer 50 in association with the current user.

The control unit 11 having received the processing details specification information list displays, on the touch screen 31, the job memory selection screen 130 (FIGS. 13 and 14) on which are displayed designations of the processing details specification information items in the received processing details specification information list (S252). The processing details specification information list to be transmitted by the scan agent computer 50 is information, wherein the designations of the respective processing details specification information items stored in the computer 50 in association with the current user are arranged in sequence of time and date from the most recent date to the oldest date indicated by the designations and in a position after a group of designations of processing details specification information items (arranged in order of designation). Processing to be performed by the control unit 11 in S252 is to display the job memory selection screen 130 by utilization of the designations of the respective processing details specification information items obtained by the scan agent computer 50 in the sequence of designations in the processing details specification information list. Specifically, when the processing details specification information is not registered by the administrator (see FIG. 15), the job memory selection screen 130 as shown in FIG. 13 is displayed through processing pertaining to S252. When the processing details specification information is registered by the administrator (see FIG. 16), the job memory selection screen 130 as shown in FIG. 14 is displayed through processing pertaining to S252.

When either the setting memory button 131 or the history button 131 on the job memory selection screen 130 has been pressed, the control unit 11 sends, to the scan agent computer 50, the processing details specification information request including the designation of the selected processing details specification information (the designation of the pressed button) (S253).

The scan agent computer 50 having received the processing details specification information request reads the processing details specification information (the processing details specification information set by the administrator or the processing details specification information stored in the HDD as a result of the scan data transmission operation having been performed by the current user) specified by the designation of the processing details specification information included in the processing details specification information request; and returns the thus-read processing details specification information to the control unit 11 (S352).

The control unit 11 having received the processing details specification information displays, on the touch screen 31, the scan basic screen 110 complying with the received processing details specification information (S254).

As has been described, the digital multifunction machine 10 of the present embodiment is arranged as an apparatus which utilizes the HDD of the scan agent computer 50 as a device utilized for storing processing details specification information items. Accordingly, despite being able to operate under registered conditions, the digital multifunction machine 10 is realized as an apparatus which can be manufactured less expensively than is such an existing machine, by the amount stemming from obviation of a necessity for providing the information processing apparatus with a large-capacity nonvolatile storage medium.

The information processing system of the present embodiment is arranged as a system which automatically stores, in the scan agent computer 50, the processing details specification information indicative of the processing condition of the scan data transmission operation having been executed by each user with the information processing system. The information processing system of the present embodiment is arranged also as a system by which the processing details specification information stored in the scan agent computer 50 can be used from each of the digital multifunction machines 10 forming the system with easy operation (depressing the job memory button 32c and then depressing the button 131). Accordingly, a working environment, which cannot be realized with the conventional digital multifunction machines until the same processing condition is registered in each of the conventional digital multifunction machines, can be realized without performing any registration of the processing details specification information.

<Modification>

The digital multifunction machine 10 of the present embodiment is susceptible to various modifications. For instance, the previously-described digital multifunction machine 10 is an apparatus which performs special processing. However, the scan agent computer 50 may be embodied as a computer in which a common folder is set, and the digital multifunction machine 10 may also be used as a copier which utilizes a shared folder of the computer for storing processing details specification information.

The digital multifunction machine 10 may also be modified such that storage of the processing details condition information is not performed on a per-user basis.

The information processing system of the present embodiment is susceptible to various modifications. For instance, the previously-described information processing system is a system which performs scan data transmission operation. However, each digital multifunction machine 10 may be constructed as a simple copier machine, and the scan agent computer 50 may be constructed as a device that obtains copy condition information from each copier machine and that supplies stored copy condition information to a copier machine having sent a predetermined request thereto.

The information processing system may also be modified such that storage of the processing details condition information is not performed on a per-user basis. Further, the information processing system may be modified such that an admimistrator can register processing details condition information commonly available by each digital multifunction machine 10.

1. An information processing apparatus used while being connected to a network, comprising:
processing condition specification information storage means for storing processing condition specification information formed from a plurality of element information items;
information processing execution means capable of performing information processing whose details are specified by said processing condition specification information stored in said processing condition specification information storage means;
user interface means capable of enabling a user to select one from said processing condition specification information items stored in a predetermined device in said network and changing element information items forming said processing condition specification information stored in said processing condition specification information storage means to element information items whose details are specified by said user; and
rewriting means for rewriting said processing condition specification information stored in said processing condition specification information storage means to processing condition specification information selected by said user when said user has selected a certain processing condition specification information item stored in said predetermined device by utilization of said user interface.

2. The information processing apparatus according to claim 1, wherein said information processing execution means is means for storing said processing condition specification information stored in said processing condition specification information storage means when information processing is performed.

3. The information processing apparatus according to claim 1, wherein said information processing execution means is means which acts after said user has input identification information thereof by utilization of said user interface means and means for storing said processing condition specification information stored in said processing condition specification information in said predetermined device in association with user identification information input at that point in time.

4. The information processing apparatus according to claim 2 or 3, wherein said predetermined device comprises:
storage means for storing a plurality of processing condition specification information items in a pattern so as to be distinguishable according to date and hour information; and
processing condition specification information number adjustment means which changes date and time information to be used for identifying said processing condition specification information to a current date and time when processing condition specification information to be stored in said storage means is given by said information processing execution means of said information processing apparatus and processing condition specification information whose details are identical with those of said processing condition specification information given by said information processing execution means are present in said processing condition specification information stored in said storage means; and which, when not present in said processing condition specification information stored in said storage means, stores said processing condition specification information in a pattern so as to be distinguished by data and time information representing a current date and time.

5. An information processing system in which a plurality of information processing devices and a management device are connected to a network, wherein:
the management device includes information storage means formed from a plurality of element information items; and, each of the information processing devices includes:
processing condition specification information storage means for storing processing condition specification information formed from the plurality of element information items;
information processing execution means capable of performing information processing specified by the processing condition specification information stored in the processing condition specification information storage means;
user interface means capable of prompting a user to select one from processing condition specification information items stored in information storage means of the management device and changing the respective element information items forming the processing condition specification information stored in the processing condition specification information storage means to element information items specified by the user; and
rewrite means for rewriting the processing condition specification information stored in the processing condition specification information means to processing condition specification information selected by the user when the user has selected a certain processing condition specification information item stored in the management device by utilization of the user interface means.

6. The information processing system according to claim 5, wherein:
the information storage means of the management device includes means capable of storing a plurality of processing condition specification information items according to the identification information about a user; and
the user interface means of the information processing device include means capable of selecting one processing condition specification information item from the processing condition specification information items stored in the management device in association with the identification information after the user has input his/her identification information.

7. The information processing system according to claim 5, wherein the information processing execution means of the information processing device includes:
means which functions after the user has input his/her identification information by utilization of the user interface means, and
means for storing the processing condition specification information stored in the processing condition specification information storage means in processing condition specification information storage means of the management device in association with the identification information about the user input at that point in time.

8. The information processing system according to claim 7, wherein the management device further comprises:
processing condition specification information number control means for controlling, to a predetermined number or less for each user identification information item, the number of processing condition specification information items stored in the information storage means associated with the identification information.
